(19) United States
(12) Patent Application Publication
(10) Pub. No.: US 2011/0037353 A1
(43) Pub. Date: Feb. 17, 2011

(54) METHOD FOR MANUFACTURING THE FRAME OF AN ELECTRIC MACHINE, AN ELECTRIC MACHINE AND A FRAME OF AN ELECTRIC MACHINE

(75) Inventor: Matti Rantapaa, Oulu (FI)

Correspondence Address: ZIEGLER IP LAW GROUP, LLC., 518 RIVERSIDE AVENUE, BUILDING B (Synergy), WESTPORT, CT, 06880, US

(73) Assignee: RANDAX OY, Oulu (FI)

(21) Appl. No.: 12/988,476

(22) PCT Filed: Apr. 7, 2009
(86) PCT No.: PCT/FI09/50259

§ 371 Date: Oct. 18, 2010

(30) Foreign Application Priority Data
Apr. 18, 2008 (FI) 20085331

(51) Int. Cl. H02K 1/20; H02K 15/00

(52) U.S. Cl. 310/60 A; 29/596

(57) ABSTRACT

A method for manufacturing the frame of an electric machine in which stator is formed, a first sheath of sheet metal is formed around and attached to a stator by laser welding and a cooling element is attached to the first sheath by laser welding. The electric machine includes at least a frame, a stator attached to the frame, an axis, a rotor attached to the axis and the front flange to which a bearing casing has been fitted in order to fit the bearing used to support the axis. The bearing casing has been fitted into the front flange in such a manner that the bearing can be placed into the bearing casing from inside the frame. In addition, the disclosure relates to the frame of an electric machine.

### CROSS-REFERENCE TO RELATED APPLICATIONS

This application is the U.S. National Stage of International Application No. PCT/FI2009/050259, filed on 7 Apr. 2009, which designated the United States of America and which was published under PCT Article 21 (2) as Publication No. WO 2009/127781 A1 and which claims priority to and the benefit of Finnish Application No. 20085331, filed 18 Apr. 2008, the disclosures of which are incorporated herein by reference in their entireties.

### BACKGROUND

1. Field

The disclosed embodiments relate to a method for manufacturing the frame of an electric machine. In addition, the disclosed embodiments relate to an electric machine and a frame of an electric machine.

2. Brief Description of Related Developments

Typically the frame of an electric machine is formed of casted metal parts. Casting moulds and metal foundry is required for manufacturing casting parts. Castings are affordable as such but mould, storage and logistics costs considerably increase the total costs. Because of the somewhat high starting costs the use of casting parts is affordable in connection with large batches. The aim is to find more affordable solutions for manufacturing small batches in other ways than using casting parts. One method to manufacture the frame of an electric machine is to form suitable metal parts by welding. However, the welding methods used today are generally demanding and easily cause measuring errors and tension in the product for which reason extra machining is necessary in the manufacturing. There is a need for finding a better solution for manufacturing single frames of electric machines.

### SUMMARY

Now, a solution has been found that enables a cost-effective way to manufacture frames of electric machines also in small production batches.

To attain this purpose, one embodiment relates to a method for manufacturing a frame which includes forming a stator, forming a first sheath around the stator and attaching the first sheath to the stator, forming a cooling element and attaching the cooling element to the first sheath, forming a second sheath and attaching the second sheath to the cooling element, wherein the first and second sheaths are comprised of sheet metal.

Another aspect of the exemplary embodiments relates to an electric machine having a frame, a stator attached to the frame, an axis, a rotor attached to the axis, a first sheath surrounding the stator, a cooling element attached to the first sheath, and a second sheath attached to the cooling element, wherein the first sheath, the cooling element, and the second sheath are comprised of sheet metal.

A further aspect of the disclosed embodiments relates to a frame of an electric machine having a stator, a first sheath surrounding the stator, a cooling element attached to the first sheath, a second sheath attached to the cooling element, wherein the first sheath, the cooling element and the second sheath are comprised of sheet metal.

The basic idea of the manufacturing method is that the cut and partly bended parts are welded around a stator and finally only guides and fastening holes are machined, if needed. With this method small batches can be manufactured with reasonable costs and casting parts can be avoided.

In the method according to the aspects of the disclosed embodiments, sheet metal forms a first sheath around the stator which sheath is attached to the stator by laser welding, as well as a cooling element which is attached to the first sheath by laser welding.

In one embodiment, a second sheath of sheet metal is attached to the cooling element by laser welding.

In one embodiment, the cooling element is formed of sheet metal by corrugating.

In one embodiment, a front flange is also formed in the frame and a bearing casing is formed in connection with the front flange to which casing a bearing can be fitted from inside the frame.

In one embodiment, an electric machine comprises at least a frame, a stator attached to the frame, an axis, a rotor attached to the axis and the front flange to which a bearing casing is fitted in order to fit the bearing used to support the axis. Bearing casing is fitted into the front flange in such a manner that the bearing can be placed into the bearing casing from inside the frame.

In one embodiment, the frame comprises the first flange formed of sheet metal which flange has been attached to the stator by laser welding and a cooling element formed of sheet metal which element has been attached to the first sheath by laser welding.

In one embodiment, the rotor is permanently magnetized.

In one application, a welding robot is used in the welding.

The different embodiments of the above-described arrangement, taken separately and in various combinations, provide several advantages. A significant advantage is that there is no need for casting mould wherein adjusting the manufacturing to different machines is easy and it is possible to manufacture small production batches.

An advantage of an application is that the machining work needed in the manufacturing of an electric machine decreases compared to solutions of prior art. At the best, machinings can be avoided altogether.

The previous advantages result in that there is no need for intermediate storage which in solutions of prior art is needed for the casting moulds or for the products transferred from one work step to another.

An advantage of an electric machine application is, in turn, that the bearing of the electric machine can be changed from inside the frame, i.e. from the rear end of the machine. Thus, the machine can be attached from its front flange to other structures. Thus, the maintenance and repair becomes easier and faster.

### BRIEF DESCRIPTION OF THE DRAWINGS

In the following, the aspects of the disclosed embodiments will be described in more detail with reference to the appended principle drawings, in which

FIG. 1 shows an embodiment of an electric motor incorporating aspects of the present disclosure.

FIG. 2 shows a cross-section of the embodiment according to FIG. 1.

FIG. 3 shows a perspective view of the embodiment according to FIG. 2.

FIG. 4 shows a cross-sectioned perspective view of another embodiment of an electric motor incorporating aspects of the present disclosure.

FIG. 5 shows a cross-sectioned perspective view of a third embodiment of an electric motor incorporating aspects of the present disclosure.

FIG. 6 shows a perspective view of an electric motor according to an embodiment incorporating aspects of the present disclosure.

FIG. 7 shows a cross-section view on a perpendicular plane in relation to the axial line of the embodiment according to FIG. 6.

FIG. 8 shows a detail of enlarged FIG. 7.

FIG. 9 shows a cross-section view parallel with the axial line of the embodiment according to FIG. 6.

For the sake of clarity, the drawings only show the details necessary for understanding the aspects of the disclosed embodiments. The structures and details that are not necessary for understanding the disclosed embodiments but are obvious for anyone skilled in the art have been omitted in the figures in order to emphasize the aspects of the disclosed embodiments.

### DETAILED DESCRIPTION OF THE DISCLOSED EMBODIMENTS

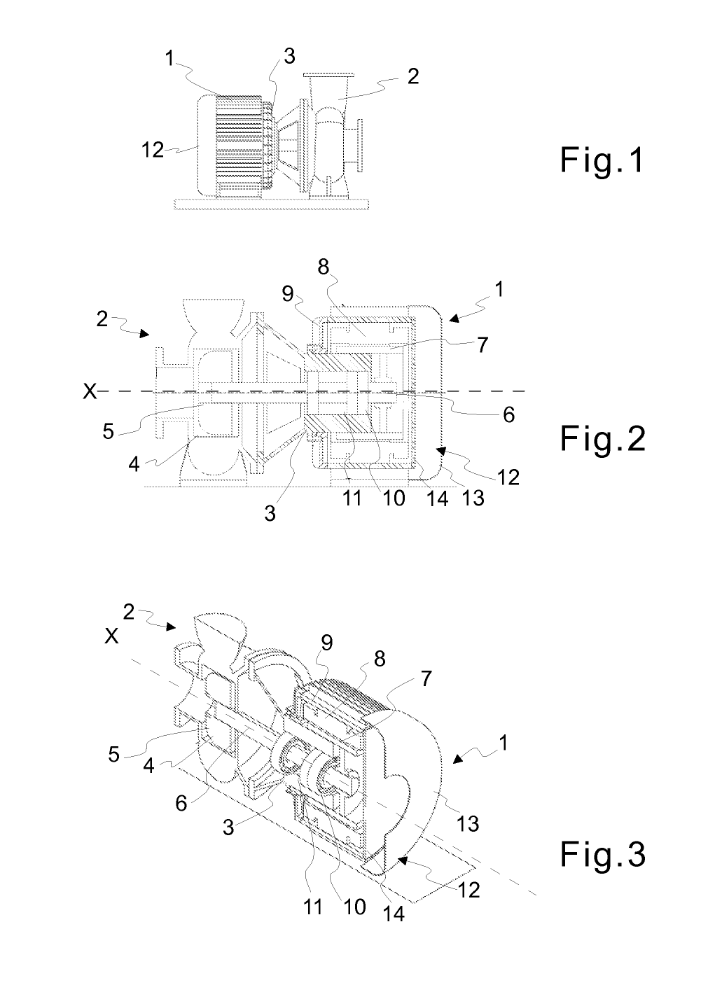

FIGS. 1 to 3 show an embodiment of an electric machine incorporating aspects of the disclosed embodiments. In the example, electric motor 1 is coupled to the pump 2 with the same axis. Coupling is conducted at the end of the front flange 3 of the electric motor 1, i.e. front end of the electric motor. In FIGS. 2 and 3 are shown a casing 4 of the pump 2 as well as an impeller 5. In the example, the impeller 5 is coupled to the common axis 6 with the electric motor 1 and most preferably at the end of the axis.

The electric motor 1 comprises an axis 6, a rotor 7, a stator 8 as well as a frame 9. The axis 6 and the rotor 7 are coupled to each other and their combination is fitted to rotate around the axial line X (rotating axis) of the axis. In the example, rotor 7 is permanently magnetized. Rotor 7 can be attached to the axis 6 in several different ways. For example, different couplings can be used to the attaching, wherein the attachment points of couplings are placed in the space between axis 6 and rotor 7. Using couplings advantageously enables the releasing of the axis 6 and rotor 7 from each other and removing of either part without having to remove both parts. For example, during maintenance of axis 6 it is advantageous to leave rotor 7 in place and only to remove the axis from the machine.

Axis 6 is supported to frame 9 of the electric motor with bearings 10 which are located in the bearing casing 11 in the vicinity of the front flange 3 of the electric motor 1. The bearing casing 11 has been formed in the machines according to examples so that the axis 6 and bearings 10 can be fitted into the bearing casing from the rear end direction 12 of the motor. Preferably, the bearings 10 can be replaced without removing the front flange 3 of the electric motor 1. There is also no need for the bearing supporting the axis 6 at the rear end 12 of the machine in the presented application. In addition, in the presented advantageous embodiment, the bearing assembly is shared by both the motor 1 and the pump 2. The frame 9 of the electric motor 1 is advantageously responsible for supporting the rear end of the pump 2 and/or bearing casing 11. Thanks to the shared bearings of the pump 2 and motor 1, the bearing losses decrease and the structure is simplified.

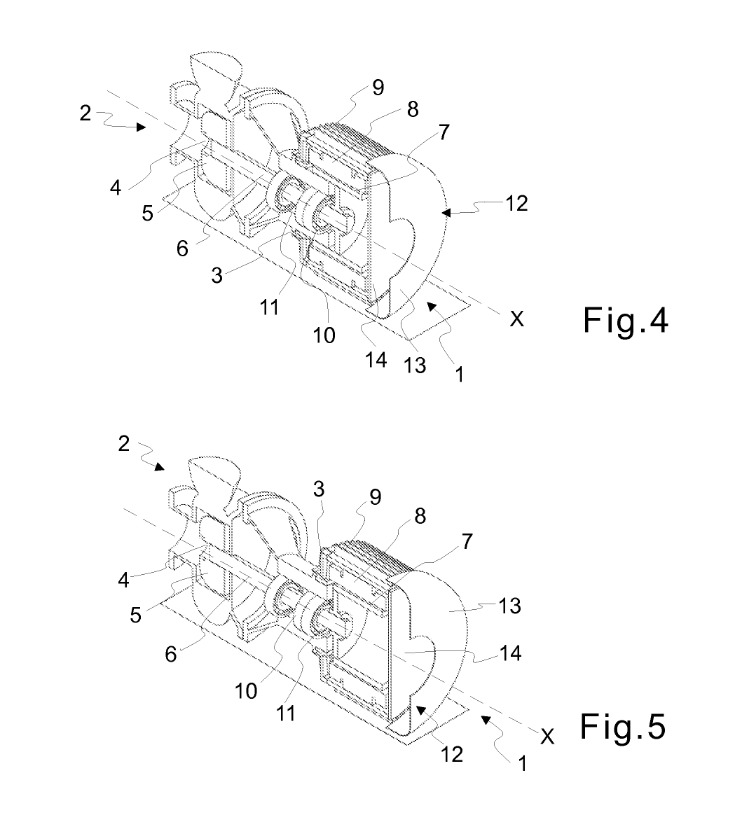

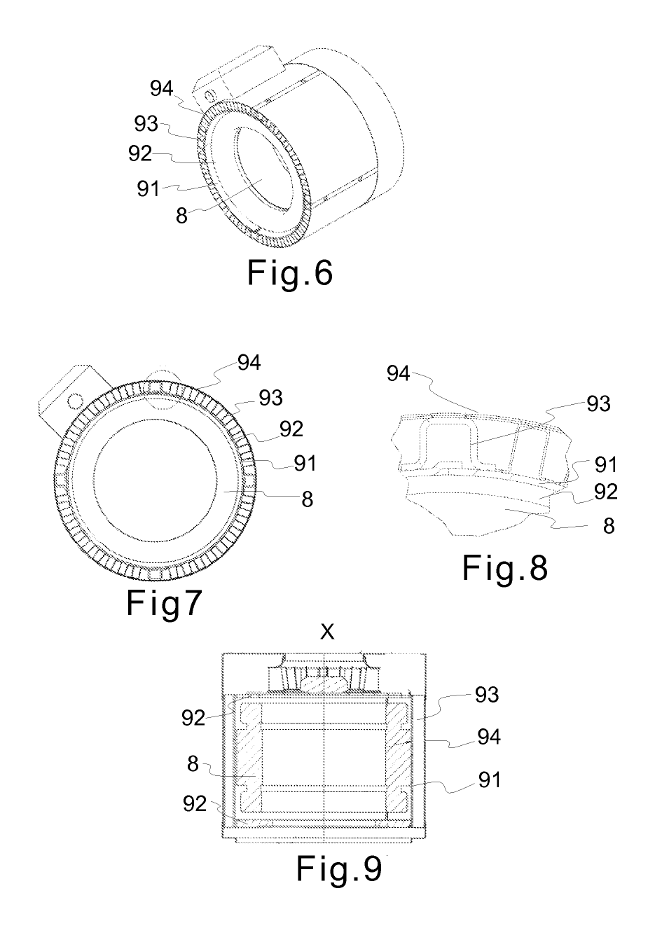

The rotor 7 can be formed in several different manners wherein the length of the electric machine 1 in the axis direction can be affected. In the embodiments according to FIGS. 1 to 3, the aim has been to create the size of the electric machine to be as short as possible. In the FIGS. 4 and 5 has been presented two other advantageous applications in which rotor 7 has been shaped to be different from the solution presented in FIGS. 1 to 3. By transferring the rotor 7 further away from bearing casing 11, a lot more space is produced, for example, for the lubrication system of the bearings 10. Rotor 7 can be different in some applications, for example it can have a solid structure or it can comprise a cage winding or grooves.

In the embodiments according to FIGS. 1 to 5, it is possible to open the electric machine 1 from the rear end 12, for example, for maintenance or repair. After removing fan cover 13 and rear lid 14 it is possible to reach the rotor 7 through the opening at the rear end 12 of the electric machine 1. Depending on the structure of the rotor 7, it is possible to remove either the whole rotor 7 or release the connection between the 15 rotor and axis 6. After that, it is possible to remove the axis 6, bearings 10 and/or sealings through the rear end 12 of the electric machine. This enables the maintenance and/or replacement of the so called wearing parts of the electric machine 1, for example, without having to remove the connection between the electric machine and pump 2. Thus, the maintenance is easier and quicker than in traditional electric machines in which the connection often has to be dismounted when beginning maintenance. In a corresponding manner, the axial line X has to be realigned after maintenance. As an example, an apparatus has been used in which an electric machine 1 has been connected to a pump 2. The electric machine 1 can be connected to other devices, such as a blower, a conveyer, a work machine. The basic idea is to connect the axis 6 end of the electric machine 1 and advantageously also the front flange 3 to another device. In one embodiment, the bearing assembly 10 is shared by the motor 1 and the device connected to the motor, for example a pump 2. Thanks to the above-presented structure, the connection between the electric machine 1 and the other device 2 does not have to be removed because of, for example, maintenance or repair of bearings.

It is possible to form the above-presented electric motor 1 in several different ways. For example, casted metal parts can be used as frame structures 9. In the following, one advantageous method to form the frame 9 of an electric motor will be described.

The method is based on the use of metal sheets having a thickness that varies according to the size of machine and the basis of use. It is advantageous to use laser welding to the joints of the metal sheet whereby the forming welded seam is controllable and the weld does not draw. In addition, laser welding enables joining the first material to the second material by welding through either one of the material layers. Thus, there is no need for welding openings in the sheets. A welding robot can be used in the method. Different machines can be manufactured with the same robot by changing the settings of the program and tools whereby the production line easily enables the manufacturing of different machines.

In one embodiment, a sheet metal ring 91 is installed on top of the sheet package of the stator 8. The sheet metal ring 91 can be installed either as a one or several piece so that it creates a pipe, i.e. the first sheath 91. The first sheath 91 is attached to the back of the stator 8 by laser 20 welding. Preferably, the welding is performed through the surface of the first sheath 91 wherein a welded joint is formed between the first sheath 91 and stator 8. Preferably, the welding is performed as one or several hoop-like circles that circulate the axial line X.

Flanges 92 are advantageously welded to the ends of first flange 91. Flanges 92 support and stiffen the structure. Flanges 92 can be formed in different ways, for example by laser cutting a suitable piece from sheet metal. Also at this point, the welding method is advantageously laser welding wherein the welding can be done to the flange 92 through the wall of the pipe 91 and at the same time the forming welded seamis controllable.

On top of the first flange 91 is attached a bended cooling plate 93 made of sheet metal. In the example, the bendings of the cooling plate 93 are substantially U-shaped but the bendings can also be shaped otherwise. For example, the bendings can be more V-shaped and it is also possible to combine different bendings to the same cooling plate 93. Advantageously, the cooling ribs formed by the cooling plate 93 are substantially in the direction of the axis of the electric machine. The cooling plate 93 is welded to the first sheath 91 by laser. Preferably, the welding is performed through the surface of the cooling plate 93 wherein a welded joint is formed between the cooling plate 93 and the first flange 91. The welding is performed advantageously from the bottom of each crimp substantially in the direction of the axial line X. In the finished structure the cooling plate 93 acts advantageously as a part of the frame 9 of the electric machine.

In one application a second metal sheet sheath 94 is fitted on top of the cooling plate 93. In one embodiment, the second metal sheet flange 94 is attached by laser welding. Preferably, the welding is performed through 15 the surface of the second flange 94 wherein a welded joint is formed between the second flange 94 and the cooling plate 93. At the same time, pipe 91, cooling plate 93 and sheath 94 form a rigid and tough cell structure. The second sheath 94 acts, for example, as a protective sheath to the electric machine 1, preventing such as the soiling of the cooling structure.

A medium flow is directed into channels of the cooling cells situated between the cooling plate 93 and flanges 91, 94 in the finished electric machine 1, which cooling medium keeps the temperature of the electric machine within allowed limits. For example, the medium can be air or other gas but fluid can also be used if the structure has been made sufficiently tight. In one application air is used for cooling, which air flow is generated with a fan (not shown in Figures) situated at the end of the electric machine 1 or fan blades (not shown in Figures) situated at the end of axis 6.

The above-mentioned manufacturing method of an electric machine 1 can be applied for manufacturing different kinds of electric machines than presented in the example. For example, the electric machine 1 can be an electric motor or generator. The power of the electric machine can also vary but the method is designed to be advantageous in manufacturing machines having power, for example, of 10 to 1000 kW.

By combining, in various ways, the modes and structures disclosed in connection with the different embodiments of the disclosure presented above, it is possible to produce various embodiments of the invention in accordance with the spirit of the invention. Therefore, the above-presented examples must not be interpreted as restrictive to the invention, but the embodiments of the invention may be freely varied within the scope of the inventive features presented in the claims hereinbelow.

What is claimed is:

1. A method for manufacturing the frame (1) of an electric machine (9) in which method
a stator (8) is formed,
the first sheath (91) is formed around the stator (8),
a cooling element (93) is formed of sheet metal which element is attached to the first sheath (91)
characterized in that, in addition,
the first sheath (91) is formed of sheet metal and it is attached to the stator (8),
the second sheath (94) formed of sheet metal is attached to the cooling element (93).

2. The method according to claim 1, characterized in that the cooling element (93) is formed of sheet metal by corrugating.

3. The method according to claim 1 or 2, characterized in that the first sheath (91) and the second flange (94) is attached to the cooling element (93) by laser welding.

4. The method according to any of the preceding claims, characterized in that a front flange (3) is also formed to the frame (9) and a bearing casing (11) is formed in connection with the front flange, in which casing can be provided a bearing (10) from inside the frame.

5. The electric machine comprises at least a frame (9), a stator (8) attached to the frame, an axis (6), a rotor (7) attached to the axis and in addition, the electric machine comprises the first sheath (91) surrounding the stator (8) and a cooling element (93) attached to the first sheath (91),
characterized in that the electric machine comprises a second sheath (94) attached to the cooling element (93), and in addition, the first sheath (91), the second sheath (94) as well as the cooling element (93) are formed of sheet metal.

6. The electric machine according to claim 5, characterized in that the first flange (91) and the second flange (94) is attached to the cooling element (93) by laser welding.

7. The electric machine according to claim 5 or 6, characterized in that the electric machine comprises a front flange (3) of a frame (9), to which flange a bearing casing (11) has been arranged in order to fit bearings (10) supporting axis (6), and the bearing casing (11) has been arranged to the front flange (3) in such a way that the bearings (10) can be placed into the bearing casing from inside the frame (9).

8. The electric machine according to any of the preceding claims 5 to 7, characterized in that the rotor (7) is permanently magnetized.

9. An apparatus that comprises an electric machine (1) according to any of the preceding claims 5 to 8.

10. The apparatus according to claim 9, characterized in that the apparatus comprises a pump (2) which is attached to the front flange (3) of the electric machine (1) and to the axis (6).

11. The frame (9) of the electric machine, which frame comprises at least a stator (8), the first sheath (91) surrounding the stator, and the cooling element (93) attached to the first sheath (91), characterized in that the frame comprises the second sheath (94) attached to the cooling element (93), and in addition, the first sheath (91), the second sheath (94) as well as the cooling element (93) have been formed of sheet metal.

12. The frame of an electric machine according to claim 11, characterized in that the first sheath (91) and the second sheath (94) is attached to the cooling element (93) by laser welding.
